(19) United States
(12) Patent Application Publication
(10) Pub. No.: US 2016/0196507 A1
(43) Pub. Date: Jul. 7, 2016

(54) TICKET AND CONVEYANCE MANAGEMENT SYSTEMS

(71) Applicant: TRANSPORTME PTY LTD, Coffs Harbour (AU)

(72) Inventor: Nigel Reginald Tooth, Coffs Harbour (AU)

(21) Appl. No.: 14/897,809

(22) PCT Filed: Jun. 13, 2014
(86) PCT No.: PCT/AU2014/050070

§ 371 Date: Dec. 11, 2015

(30) Foreign Application Priority Data
Jun. 13, 2013 (AU) 2013902134

(51) Int. Cl. G06Q 10/02; G06Q 50/30; G06Q 30/00; H04W 4/02; G06Q 20/28

(52) U.S. Cl. CPC G06Q 10/02; H04W 4/021; G06Q 20/28; G06Q 30/018; G06Q 50/30

(57) ABSTRACT

Disclosed is a processing system, method, system, computer readable medium and server processing system for ticket and conveyance management. In one aspect, the processing system is configured for ticket management of a conveyance, wherein the processing system includes a processor, a memory and a GPS unit, wherein the processing system is configured to: determine, using the GPS unit, a current location of the conveyance; receive a request to issue a ticket to a passenger, wherein the request is indicative of the destination for the passenger; generate a ticket based on the current location and the destination; and store a ticket record in the memory.

### CROSS-REFERENCE TO RELATED APPLICATIONS

The present application claims priority from Australian Provisional Patent Application No 2013902134 filed on 13 Jun. 2013, the content of which is incorporated herein by reference.

### FIELD OF INVENTION

The present invention relates to a ticket management system for a conveyance and a conveyance management system for a conveyance fleet.

### BACKGROUND

Currently ticket issuing machines that exist on a conveyance, such as a bus, are fairly crude. Such devices either require substantial input from the driver in order to issue a ticket, and/or potentially the driver is required to manually determine what is a sufficient ticket to issue for a new passenger (i.e. the driver may need to be aware that a ticket for four sections has to be issued for the pick-up and destination indicated by the new passenger). In order for drivers to meet required transport schedules, the ticket issuing process needs to be conducted expeditiously which currently is an issue as the passenger has to verbally convey the destination and potentially the type of ticket to the driver.

In addition, passengers are required to typically indicate to the driver of the conveyance to stop at their stop along the route. For example, a button or chain is usually pressed or pulled to activate a signal such that the driver is aware that the conveyance should stop at the next designated location. However, in the event that a passenger is unfamiliar with the area, the passenger may not be aware when to indicate to the driver to stop. Upon boarding, the passenger may request the driver to stop at a particular stop due to their unfamiliarity with the area, however it is common that the driver forgets this request due to the number of passengers being catered for as well as the driver's concentration on operating the conveyance.

Another problem that exists in the conveyance industry is a passenger waiting for the conveyance to arrive. For example, in the bus industry, this can be problematic as the passenger is provided no feedback as to where the bus in currently on route and how long should the passenger wait until arranging for alternate means of transport.

Therefore, there is a need to alleviate one or more of the above-mentioned disadvantages.

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

### SUMMARY

This summary is provided to introduce a selection of concepts in a simplified form that are further described below in the Preferred Embodiments. This summary is not intended to identify key features or essential features of the claimed subject matter, nor is it intended to be used to limit the scope of the claimed subject matter.

In a first aspect there is provided a processing system for ticket management of a conveyance, wherein the processing system is a mobile device including a processor, a memory and a GPS unit, wherein the processing system is configured to:
determine, using the GPS unit, a current location of the conveyance;
receive a request to issue a ticket to a passenger, wherein the request is indicative of the destination for the passenger;
generate a ticket based on the current location and the destination; and
store a ticket record in a ticket data store of the memory.

In certain embodiments, the processing system is configured to instruct a printer to print a physical version of the ticket.

In certain embodiments, the processing system determines, using the current location, one or more ticket records in the memory, and route data stored in the memory, if the conveyance is to stop at an upcoming location, wherein in response to a positive determination the processing system indicates a stop reminder.

In certain embodiments, the processing system includes or is in communication with a coded data capturing device, wherein the processing system is configured to:
receive captured data from the coded data capturing device operated to scan pre-purchased ticket data presented by a passenger processing system associated with the passenger, wherein the pre-purchased ticket data is indicative of a pre-purchased ticket by the passenger;
determine based on at least one of ticket data stored in memory and a remote ticket data store, whether the pre-purchased ticket is valid; and
present, based on the determination, the validity of the pre-purchased ticket.

In certain embodiments, the processing system includes or is in communication with a coded data capturing device, wherein the processing system is configured to:
receive captured data from the scanner device operated to capture coded data presented by a passenger processing system associated with the passenger, wherein the captured data is indicative of a ticket details for a requested ticket for the passenger; and
generate the ticket based on the current location and the ticket details indicated by the captured data.

In certain embodiments, the processing system is configured to:
determine an identity for a passenger processing system associated with the passenger for purchasing a ticket; and
presenting an alert in the event that a signal indicative of the identity of the passenger processing system is received after the conveyance has proceeded past the passenger's destination.

In certain embodiments, the processing system is configured to:
determine, using the GPS unit, a plurality of time-stamped locations whilst the conveyance is travelling; and
transfer, to a server processing system, the GPS data in order to provide a current location of conveyance to one or more querying devices.

In a second aspect there is provided a computer readable medium including executable instructions for configuring a processing system for ticket management of a conveyance, wherein the processing system is a mobile device including a processor, a memory and a GPS unit, wherein the executable instructions configure the processing system to:
determine, using the GPS unit, a current location of the conveyance;
receive a request to issue a ticket to a passenger, wherein the request is indicative of the destination for the passenger;
generate a ticket based on the current location and the destination; and
store a ticket record in a ticket data store of the memory.

In certain embodiments, the processing system is configured to instruct a printer to print a physical version of the ticket.

In certain embodiments, the processing system determines, using the current location, one or more ticket records in the memory, and route data stored in the memory, if the conveyance is to stop at an upcoming location, wherein in response to a positive determination the processing system indicates a stop reminder.

In certain embodiments, the processing system includes or is in communication with a coded data capturing device, wherein the processing system is configured to:
receive captured data from the scanner device operated to capture pre-purchased ticket data presented by a passenger processing system associated with the passenger, wherein the pre-purchased ticket data is indicative of a pre-purchased ticket by the passenger;
determine based on at least one of ticket data stored in memory and a remote ticket data store, whether the pre-purchased ticket is valid; and
present, based on the determination, the validity of the pre-purchased ticket.

In certain embodiments, the processing system includes or is in communication with a coded data capturing device, wherein the processing system is configured to:
receive captured data from the coded data capturing device operated to capture coded data presented by a passenger processing system associated with the passenger, wherein the captured data is indicative of a ticket details for a requested ticket for the passenger; and
generate the ticket based on the current location and the ticket details indicated by the captured data.

In certain embodiments, the processing system is configured to:
determine an identity for a passenger processing system associated with the passenger for purchasing a ticket; and
presenting an alert in the event that a signal indicative of the identity of the passenger processing system is received after the conveyance has proceeded past the passenger's destination.

In certain embodiments, the processing system is configured to:
determine, using the GPS unit, a plurality of time-stamped locations whilst the conveyance is travelling; and
transfer, to a server processing system, the GPS data in order to provide a current location of conveyance to one or more querying devices.

In a third aspect there is provided a system for management of a conveyance fleet, wherein the system includes:
a plurality of processing systems, each processing system being configured according to the first aspect to store and transfer GPS data; and
a server processing system in communication with the plurality of processing systems.

In certain embodiments, the system includes a computer readable medium for configuring a passenger processing system, wherein the passenger processing system is configured to issue to a server processing system a request for estimated time of arrival at a departure point for a conveyance of the conveyance fleet, wherein the server processing system is configured to determine, based on the GPS data for the conveyance the estimated time of arrival and transfer a response indicative of the estimated time of arrival to the passenger processing system.

In certain embodiments, the passenger processing system includes a GPS unit, wherein the departure point of the request is generated using a current location indicated by the GPS unit of the passenger processing system.

In certain embodiments, the server processing system determines the estimated time of arrival further based on historical data.

In a fourth aspect there is provided a plurality of computer readable mediums for management of a conveyance fleet, wherein the plurality of computer readable mediums include:
a first computer readable medium configured according to the second aspect to scan coded data indicative of ticket details; and
a second computer readable medium including executable instructions for configuring a passenger processing system to generate coded data indicative of ticket details for a passenger, wherein the coded data presented by the passenger processing system is capturable by the coded data capturing device of the processing system for generating the ticket.

In a fifth aspect there is provided a plurality of computer readable mediums for management of a conveyance fleet, wherein the plurality of computer readable mediums include:
a first computer readable medium configured according the second aspect to generate GPS data; and
a second computer readable medium including executable instructions to configure a passenger processing system, wherein the passenger processing system is configured to issue to a server processing system a request for estimated time of arrival at a departure point for a conveyance of the conveyance fleet,
a third computer readable medium including executable instructions to configure the server processing system to:
   determine, based on the GPS data for the conveyance the estimated time of arrival and
   transfer a response to the passenger processing system indicative of the estimated time of arrival.

Other aspects and embodiments will be appreciated throughout the details description.

### BRIEF DESCRIPTION OF THE FIGURES

Example embodiments should become apparent from the following description, which is given by way of example only, of at least one preferred but non-limiting embodiment, described in connection with the accompanying figures.

FIG. 1 illustrates a functional block diagram of an example processing system that can be utilised to embody or give effect to a particular embodiment;

FIG. 2 illustrates an example network infrastructure that can be utilised to embody or give effect to a particular embodiment;

FIG. 3 illustrates a system diagram of an example ticket management system for a conveyance;

FIG. 4 illustrates a system diagram of an example conveyance management system for a conveyance fleet;

FIG. 5 illustrates a first screenshot of an example user interface of an application of the mobile device of a conveyance;

FIG. 6 illustrates a second screenshot of an example user interface of the application of the mobile device of a conveyance;

FIG. 7 illustrates a third screenshot of an example interface of the application of the mobile device of a conveyance;

FIG. 8 illustrates a first screenshot of an example interface generated by the server processing system;

FIG. 9 is a second screenshot of an example interface generated by the server processing system;

FIG. 10 is a third screenshot of an example interface generated by the server processing system;

FIG. 11 is a fourth screenshot of an example interface generated by the server processing system; and

FIG. 12 is a fifth screenshot of an example interface generated by the server processing system.

### DETAILED DESCRIPTION OF THE PREFERRED EMBODIMENTS

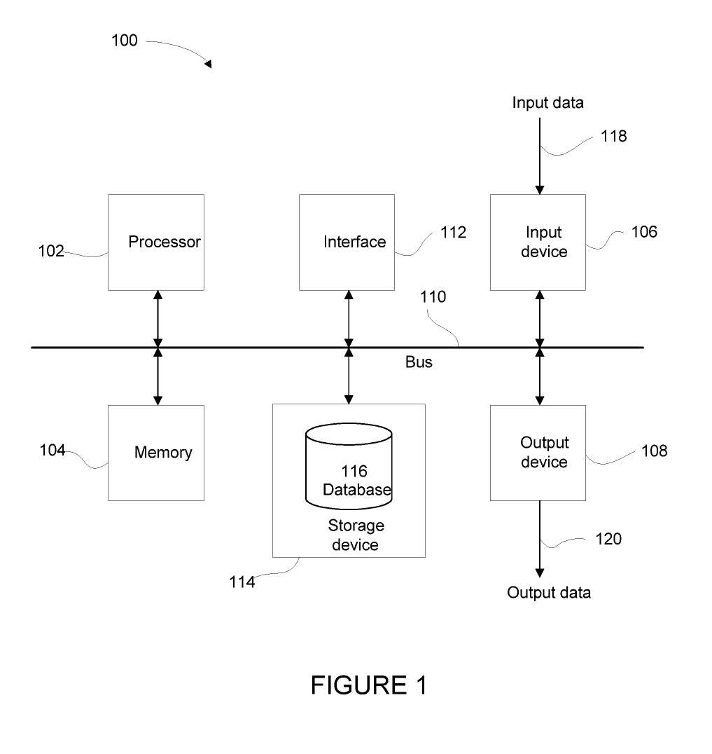

A particular embodiment can be realised using a processing system, an example of which is shown in FIG. 1. In particular, the processing system 100 generally includes at least one processor 102, or processing unit or plurality of processors, memory 104, at least one input device 106 and at least one output device 108, coupled together via a bus or group of buses 110. In certain embodiments, input device 106 and output device 108 could be the same device. An interface 112 also can be provided for coupling the processing system 100 to one or more peripheral devices, for example interface 112 could be a PCI card or PC card. At least one storage device 114 which houses at least one database 116 can also be provided. The memory 104 can be any form of memory device, for example, volatile or non-volatile memory, solid state storage devices, magnetic devices, etc. The processor 102 could include more than one distinct processing device, for example to handle different functions within the processing system 100.

Input device 106 receives input data 118 and can include, for example, a keyboard, a pointer device such as a pen-like device or a mouse, audio receiving device for voice controlled activation such as a microphone, data receiver or antenna such as a modem or wireless data adaptor, data acquisition card, etc. Input data 118 could come from different sources, for example keyboard instructions in conjunction with data received via a network. Output device 108 produces or generates output data 120 and can include, for example, a display device or monitor in which case output data 120 is visual, a printer in which case output data 120 is printed, a port for example a USB port, a peripheral component adaptor, a data transmitter or antenna such as a modem or wireless network adaptor, etc. Output data 120 could be distinct and derived from different output devices, for example a visual display on a monitor in conjunction with data transmitted to a network. A user could view data output, or an interpretation of the data output, on, for example, a monitor or using a printer. The storage device 114 can be any form of data or information storage means, for example, volatile or non-volatile memory, solid state storage devices, magnetic devices, etc.

In use, the processing system 100 is adapted to allow data or information to be stored in and/or retrieved from, via wired or wireless communication means, the at least one database 116 and/or the memory 104. The interface 112 may allow wired and/or wireless communication between the processing unit 102 and peripheral components that may serve a specialised purpose. The processor 102 receives instructions as input data 118 via input device 106 and can display processed results or other output to a user by utilising output device 108. More than one input device 106 and/or output device 108 can be provided. It should be appreciated that the processing system 100 may be any form of terminal, server, specialised hardware, or the like.

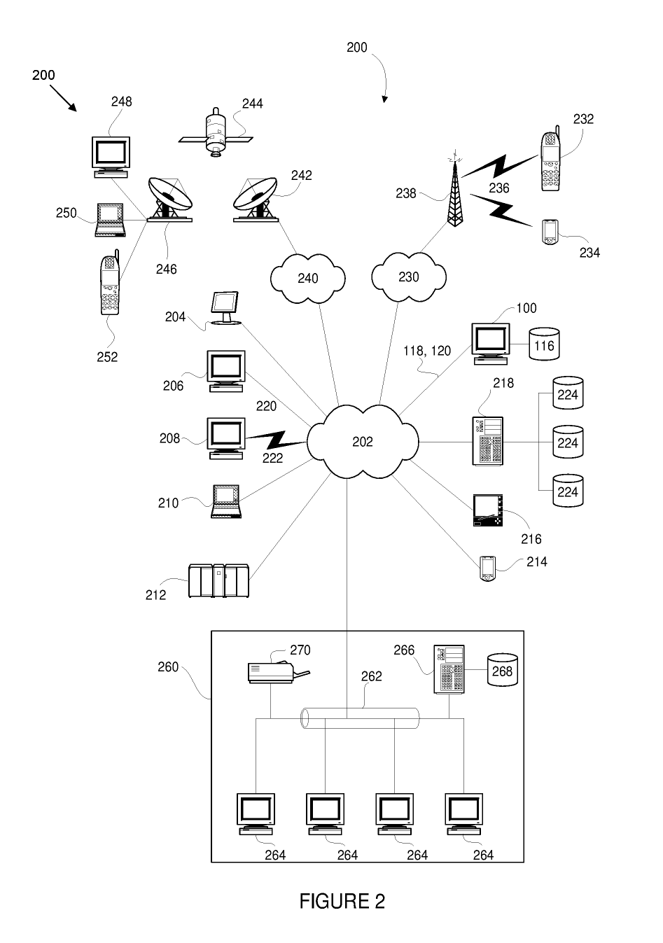

The processing device 100 may be a part of a networked communications system 200, as shown in FIG. 2. Processing device 100 could connect to network 202, for example the Internet or a WAN. Input data 118 and output data 120 could be communicated to other devices via network 202. Other terminals, for example, thin client 204, further processing systems 206 and 208, notebook computer 210, mainframe computer 212, PDA 214, pen-based computer 216, server 218, etc., can be connected to network 202. A large variety of other types of terminals or configurations could be utilised. The transfer of information and/or data over network 202 can be achieved using wired communications means 220 or wireless communications means 222. Server 218 can facilitate the transfer of data between network 202 and one or more databases 224. Server 218 and one or more databases 224 provide an example of an information source.

Other networks may communicate with network 202. For example, telecommunications network 230 could facilitate the transfer of data between network 202 and mobile or cellular telephone 232 or a PDA-type device 234, by utilising wireless communication means 236 and receiving/transmitting station 238. Satellite communications network 240 could communicate with satellite signal receiver 242 which receives data signals from satellite 244 which in turn is in remote communication with satellite signal transmitter 246. Terminals, for example further processing system 248, notebook computer 250 or satellite telephone 252, can thereby communicate with network 202. A local network 260, which for example may be a private network, LAN, etc., may also be connected to network 202. For example, network 202 could be connected with ethernet 262 which connects terminals 264, server 266 which controls the transfer of data to and/or from database 268, and printer 270. Various other types of networks could be utilised.

The processing device 100 is adapted to communicate with other terminals, for example further processing systems 206, 208, by sending and receiving data, 118, 120, to and from the network 202, thereby facilitating possible communication with other components of the networked communications system 200.

Thus, for example, the networks 202, 230, 240 may form part of, or be connected to, the Internet, in which case, the terminals 206, 212, 218, for example, may be web servers, Internet terminals or the like. The networks 202, 230, 240, 260 may be or form part of other communication networks, such as LAN, WAN, ethernet, token ring, FDDI ring, star, etc., networks, or mobile telephone networks, such as GSM, CDMA or 3G, etc., networks, and may be wholly or partially wired, including for example optical fibre, or wireless networks, depending on a particular implementation.

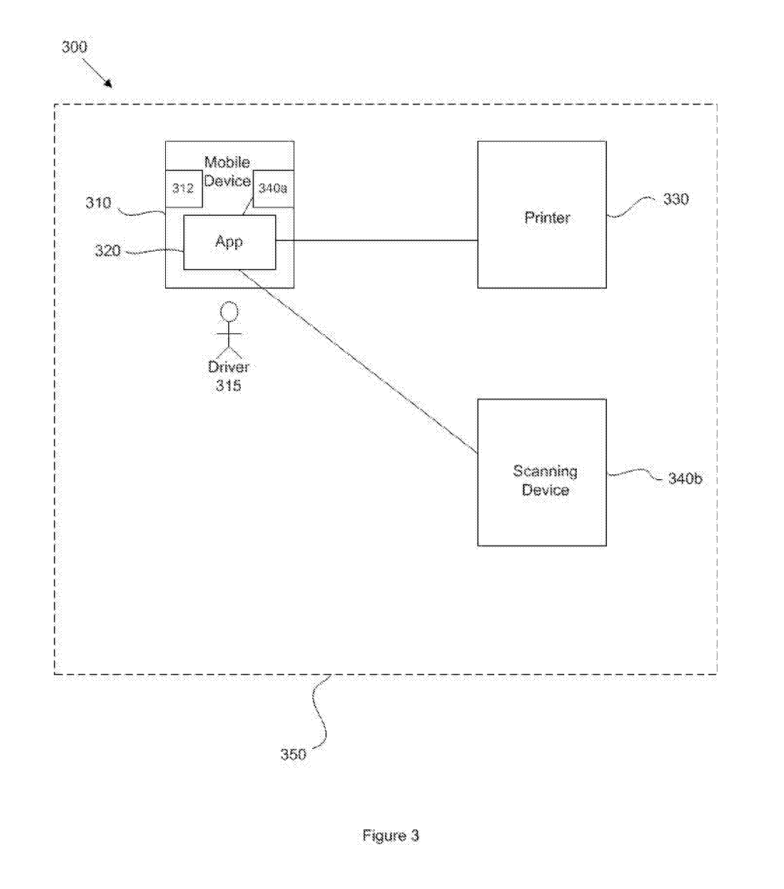

Referring to FIG. 3 there is shown a system diagram of an example ticket management system 300 for a conveyance 350.

In particular, the system 300 includes a mobile device 310 in the form of a processing system 100 as discussed in relation to FIG. 1. The processing system includes a processor 102, an input device 106, an output device 108, memory 104 and a GPS unit 312. The mobile device 310 can be a tablet processing system such as an iPad provided by Apple™, Samsung™ or the like. The mobile device 301 has stored in memory an application 320 for configuring the mobile device 310 to perform ticket management for the conveyance 350 and preferably some additional functions. The application 320 can be downloaded from an application server processing system (such as Apple AppStore™ or Google Play™, wherein the application is installed in memory of the mobile device 310.

The mobile device 310 can be releasably mounted to a stand or the like within the conveyance 350 and preferably located adjacent the driver 315 of the conveyance 350. The driver 315 can operate the mobile device 310 by providing input via the input device, such as via a touch screen, to perform ticket management for the conveyance 350 as well as other functions.

The mobile device 310 can be in communication with a printer 330 which is also located within the conveyance 350. In a preferable form, the printer 330 is in wireless communication with the mobile device 310, wherein Bluetooth protocol may be used for wireless communication between the devices. The printer 350 is preferably a thermal printer.

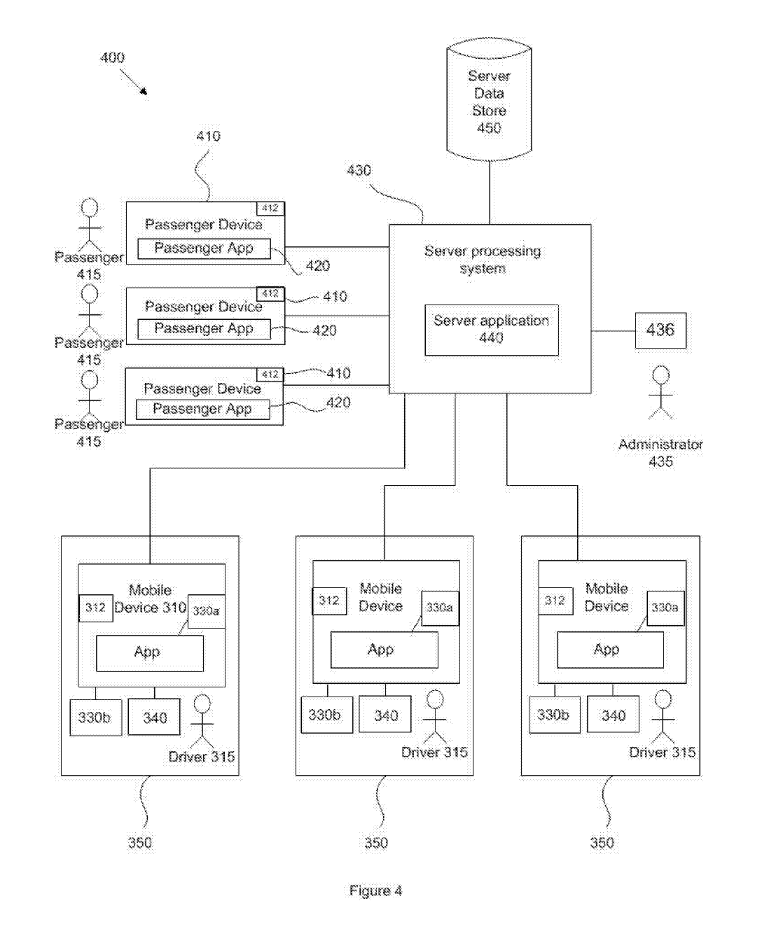

The mobile device 310 can optionally include or be in communication with a coded data capturing device 340a, 340b. In one form, the coded data capturing device 340a, 340b is a scanner device 340b which is a physically separate device to the mobile device 310. Preferably the scanner device 340b is configured to scan a screen of a second mobile device 410 (see FIG. 4) associated with a passenger 415 as will be explained in further detail below. However, it will be appreciated that it is possible for the mobile device 310 to include a camera 340a which can capture coded data. In this arrangement it is not necessary to include a physically separate scanner device due to the camera 340a of the mobile device 310 being used to capture an image of coded data from the screen of the second mobile device 310. The coded data capturing device may transfer a signal indicative of the data decoded from the read coded data. Alternatively, the coded data capturing device may provide an image which can be decoded by the processor 102 of the mobile device 310.

When a new passenger 415 boards the conveyance 350 and requires a ticket, the application 320 configures the mobile device 310 to automatically determine, using the GPS unit 312, a current location of the conveyance 350. The current location is presented in a user interface of the application 320 such that the driver 315 does not need to input this information. The driver 315 can input, via the input device of the mobile device 310, a request to issue a ticket to the passenger 415 wherein the request is indicative of the destination for the passenger 415. It will be appreciated that these steps can be performed in reverse order. However, as will be discussed in further detail below, in certain configurations ticket details may be obtained from the second mobile device 410 of the passenger such that no details need to be input by the driver. The mobile device 310, under control of the application 320, generates and stores a ticket record in a ticket data store of the memory of the mobile device 310 based on the automatic determination of the current location. After the passenger 415 purchases the requested ticket, the mobile device 310, under control of the application 320, can instruct the printer 330 to print a physical version of the ticket if required.

In certain situations, a new passenger 415 boarding the conveyance 350 may have pre-purchased a virtual ticket from a server processing system 430 (see FIG. 4) wherein a representation of the virtual ticket can be displayed via a second mobile device 410, such as a smartphone or tablet processing system or the like, associated with the new passenger 415. In this instance, the new passenger 415 operates the second mobile device 410 to present the representation of the virtual ticket. The virtual ticket can include computer readable data, such as a barcode or QR code, and textual information about the ticket. The display of the second mobile device 410 can be scanned using the scanner device 340b or the camera 340a of the mobile device 310. The application 320 decodes the captured coded data to determine ticket information such as a ticket identity of the virtual ticket. The ticket information may also be indicative of any passenger concessions, wherein the application 320 may prompt the driver to check the passenger's concession documentation.

The ticket record data store of the mobile device 310 can be searched to determine if a record exists of the pre-purchased ticket. In particular, the mobile device 310 may receive pre-purchased ticket data from the server processing system 430, wherein this data is stored in the ticket data store. In the event that the search was unsuccessful, the mobile device 310 automatically transfers a search request indicative of the determined ticket identity to the server processing system 430 to search the server data store 450. In the event that one of these searches return a valid result, the mobile device 310 can indicate that the ticket is valid. The ticket records data store in updated to indicate that the passenger with the pre-purchased ticket has boarded the conveyance 350. In the event of both searches being unsuccessful, the mobile device 310 presents an indication that the ticket is invalid.

In an alternative arrangement, the second mobile device 410 may communicate wirelessly with the mobile device 310 to provide ticket data indicative of the pre-purchased ticket. In particular, the mobile device 310 may include or is in communication with a Near Field Communication (NFC) unit, wherein the second mobile device 410 includes an NFC unit to transmit a signal indicative of the pre-purchased ticket to the mobile device 310.

During the conveyance route, the mobile device 310 periodically determines, using the current location obtained from the GPS unit 312, the one or more ticket records in the memory, and route data stored in the memory, if the conveyance is within a threshold (distance or time) of a destination of one or more passengers. In response to a positive determination the mobile device 310, under control of the application 320, indicates a stop reminder to the driver. This is advantageous as the passenger does not need to indicate to the driver 315 to stop and additionally the driver 315 does not need to remember to stop at a particular location if requested by a passenger 415 as the driver is issued an automatic reminder. The reminder is preferably audibly issued such that the driver does not necessary need to take their attention off the road. However, visual information may additionally or alternatively be presented for the reminder to the driver.

In addition, the second mobile device 410 associated with the passenger 415 may have stored thereon an application 420 which also periodically determines, using the current location obtained from a GPS unit 412 of the second mobile device 410, the data stored in memory indicative of the purchased ticket and route data, if the conveyance is within a threshold (distance or time) of the respective passenger's destination. Upon successful determination, the application 420 issues, via the screen or the speakers of the second mobile device 410, a prompt to remind the passenger that their destination is soon approaching.

During the conveyance route, the mobile device 310 is configured, under control of the application 320, to periodically determine, using the GPS unit 312, a plurality of time-stamped GPS coordinates to the conveyance's travel path. These time-stamped GPS coordinates are stored in the memory of the mobile device 310. The mobile device 310, under control of the application 320, periodically transfers, to the server processing system 430, the GPS data. As will be explained in further detail below, the server processing system 430 may receive a location request from a requesting device 410 (such as a second mobile device operated by a passenger) for a particular conveyance, wherein at least some of the time-stamped GPS data can be transferred to a requesting device for presentation. The location request may additionally include a geographical location of the requesting device (i.e. the second device may generate a current geographical location of the second device using it's GPS unit 412). The server processing system 430 can calculate a travel time estimate for the respective conveyance to travel to the geographical location of the requesting device 410.

During the conveyance route, the driver 315 may require to refuel the conveyance 350. In this regard, the driver 315 inputs via the input device of the mobile device 310 refuelling data indicative of a refuelling event for the conveyance 350, wherein the refuelling data includes an associated cost. The mobile device 310 stores the refuelling data in memory of the mobile device 310 by interacting with the input device of the mobile device 310. The mobile device 310 can transfer refuelling data to the server processing system 430 for claiming reimbursement or rebates from a government authority.

Referring to FIG. 4 there is shown a system diagram of an example conveyance management system 400 for a conveyance fleet.

In particular, the conveyance fleet includes a plurality of conveyances 350. Each conveyance 350 includes an associated mobile device 310. The system 400 also includes a server processing system 430 which is controlled by a server application 440, which is in communication with each mobile device 310. The system 400 also includes one or more passenger devices 410. The passenger devices 410 may be provided in the form of a processing system such as a smartphone, tablet, laptop or the like. Each passenger device 410 can have installed thereon a passenger application 420 for controlling the passenger device 410 to communicate with the server application 440 of the server processing system 430.

Each passenger 415 is able to launch the passenger application 420 and request an update of the location of a particular conveyance 350. The server application 440 receives the request and searches the GPS location data stored in the server data store 450 to determine a current location of the conveyance 450. The server processing system 430 under control of the server application 440 may additionally or alternatively transfer a request to the mobile device 310 associated with the conveyance 350, wherein the most recently recorded GPS data can be received by the server processing system 430. The server processing system 430, under control of the server application 440 generates a location response which is transferred to the respective passenger device 410. The server processing system 430 under control of the server application 440 may additionally estimate an arrival time to a location specified by the requesting passenger via the passenger application 420 based on historical records and the current location data.

The passenger 415 is also able to launch the passenger application 420 to pre-purchase a virtual ticket to commute between two locations as discussed previously. The passenger 415 provides ticket information and payment information or approval via the user interface of the passenger application 420 which is then transferred to the server application 440 of the server processing system 430 accordingly. In one form, the server processing system maintains an account for the user which can be debited upon receiving a pre-purchase approval. The server processing system 430 processes the pre-purchase request and generates and stores a ticket record in the server data store 450. The server processing system 430 under control of the server application 440 can transfer a record of the pre-purchased ticket to the passenger application 420 for storage in memory of the mobile device 410. Additionally or alternatively, the passenger has a link via the user interface of the passenger application 420 to the stored ticket record stored at the server data store 450, wherein the user can select the link to present information about the pre-purchased ticket via the passenger application 420. The information presented via the passenger application 420 based on either local or server memory includes computer readable data such as a QR code, a bar code, or the like. As discussed above, the scanning device 340b or camera 340a of the mobile device 310 of the conveyance 350 can be used to scan the visual coded data representation to determine validity. Alternatively, wireless communication between the second mobile device 410 and the mobile device 310, such as utilising NFC, can be utilised.

The passenger can also interact with the passenger application 420 to input ticket details of a required ticket prior to boarding the conveyance, wherein the passenger application 420 generates coded data, such as a bar code or a QR code, indicative of the ticket details input by the passenger via the user interface of the passenger application or recalled from memory. Upon boarding the conveyance, the passenger can display the QR code which is scanned by the scanner device or the camera of the mobile device 310 to determine the ticket details for the ticket required by the passenger. Upon scanning and decoding, the mobile device 310 can present to the driver via the display a cash amount required from the passenger. This feature enables the ticket details to be quickly determined and the ticket quickly issued compared to current practices. It will be appreciated that the passenger may not need to input the departure point as this is determined by the mobile device using the GPS unit 412. Additionally, the passenger application 420 can store in memory of the passenger device 410 the ticket details or the generated QR code for retrieval for future ticket applications such that in the event that purchase of the ticket is a reoccurring event for the passenger.

In one form, the coded data presented via a pre-purchased ticket or the ticket details of a required ticket can additionally be indicative of an identity for the second mobile device 410. For example, the identity of the second mobile device 410 may the MAC address of the second mobile device 410 or the device name of the second mobile device. When the coded data is scanned by the mobile device 310, the identity is decoded and the first mobile device attempts to scan for devices within a wireless proximity approximately covering the area of the conveyance. Upon detecting a signal from the respective second mobile device 415, the first mobile device 310 schedules a monitoring task in memory to be conducted shortly after departure of the respective passenger's destination. Shortly after departing (i.e. 30 seconds although this time period can be adjusted; alternatively a threshold distance traveled from the destination) from the destination for the respective passenger, the first mobile device 310 automatically scans for a signal from the second mobile device 410 to determine whether the second mobile device 315 of the passenger is within the wireless proximity approximately covering the area of the conveyance. If a signal is sensed for the respective second device 415, an alert prompt is initiated by the application 320 of the first mobile device 310 to indicate to the driver 315 that the passenger 415 has not departed from the conveyance. The driver 315 can then request that the passenger 415 depart from the conveyance. It will be appreciated that in the event that low power wireless technology is utilised, such as Bluetooth protocol, which may have a wireless communication proximity less than the area of the conveyance, the conveyance may additionally include one or more repeater devices located within the conveyance in order to adequately detect the presence of second mobile devices within the conveyance. For example, for long buses, a first repeater may be located in the middle of the bus and a second repeater toward the end of the bus.

The server application 440 of the server processing system 430 can be utilised to export reports for various purposes, such as reimbursement/rebate from a government authority, tax purposes, etc. An administrator 435 can interact with the server application 440 in order to run particular searches of the stored data and generate the reports required.

An example user interface of application 320 for the mobile device 310 of a conveyance will now be discussed. This example will be described with reference to the conveyance being a bus. However, it will be appreciated that the example is also applicable to other forms of conveyance.

Upon launching the application 320 a splash screen is presented. The splash screen is the initial screen that welcomes the driver when they select the application 320 icon from the operating system of the mobile device 310. The application 320 will also check for any updates and bug fixes at this point.

A driver login screen is then presented to the user after the splash screen. At the driver login screen, the driver is asked to provide their login information (e.g. user and password) to the application 320. This login information can be set and issued by the server processing system 430. The application 320 can either authenticate the driver or the server processing system 430 can remotely authenticate the driver based on the login details.

A screen is then presented to the driver after login allowing the driver to enter bus details, such as their bus number and their bus's odometer number. Once the driver has entered in the information it is logged into their application account.

A tutorial screen can be presented to the user via the application. If the user is logging into their application account for the first time, they are shown how to use the application via a brief tutorial.

The user 315 can interact with the interface to add a new fuel fill entry via a fuel fill entry tab 510 of the user interface. A fuel fill entry is a record of the amount of fuel that the driver loaded into the bus. The fuel fill interface also presents the previous fuel fill entries stored in memory 450 that the user has previously entered. Once a value has been exported to the server processing system 430, the value “Exported” appears next to the relevant Fuel Fill entry. The user 315 can remove past entries if they have made a mistake inputting the correct amount by tapping a remove button, which is only available next to non-exported entries. The user 315 can print a document containing the fuel fill entries, or to export a PDF of this printable document.

The user 315 can also bring up an “Add Fuel Fill Entry” form, where they can enter the fuel amount that they loaded into the bus in litres in the “Amount of Fuel” text box. The user 315 taps an add button to add and confirm this new entry or a cancel button to remove the entry from the form.

When the user 315 selects the export button, they will be required to confirm the action to export the non-exported fuel fill entries via a push notification. The non-exported entries are then transferred to memory 450 the server processing system 430 for remote storage. Once the exported entries have been successfully exported to the server processing system 430, the user receives a confirmation push notification, and the entries that were most recently exported receive an “Exported” value next to the entry text.

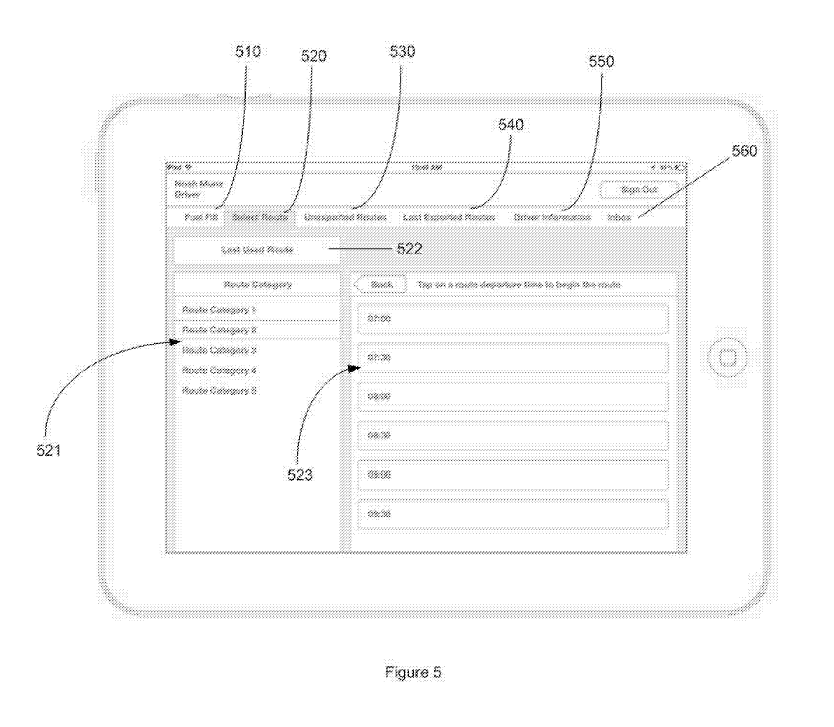

The user 315 can additionally or alternatively select a “Select Route” tab 520 from the user interface of the mobile application 310 to visit the Route Selection screen, where they can select from different routes 521 that are arranged into categories for organizational purposes. As shown in FIG. 5, the user can select a new route from the list of routes 521, or they can also opt to select the last used route 522 by tapping a “Last Used Route” button. When the user selects a route from the Route Selection screen 520, they are displayed with the route departure times 523 for the selected route. To begin a route, the user taps one of the departure times 523 which corresponds to the current location.

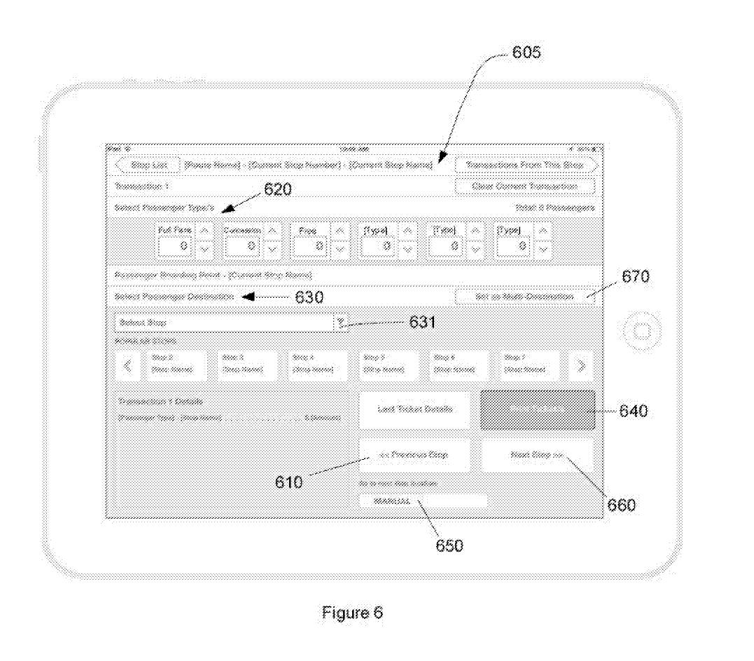

Once the user 315 has selected a route departure time, they are brought to a Create Transaction screen 605, as shown in FIG. 6, which can be auto-populated with the first stop on the route. The route name and the stop number and name are preferably always visible at the top of a Create Transaction screen. The transaction number is visible below the route name, indicating the number of the transaction within the current stop that the user is currently creating. The transaction number will automatically increase and the Create Transaction form will be emptied when a user print a ticket from this screen. Tapping the Previous Stop button 610 at the bottom of the screen takes the user to the Transaction List of the most previous stop on the route, while tapping the Next Stop button takes the user to the Create Transaction screen of the subsequent stop on the route. Route data stored in memory of the mobile device 310 or memory 450 can be used to populate the screen 605.

At the Select Passenger section 620 of the create transaction screen 605, the user can increase or decrease the number of each type of passenger to include in a transaction. The user 315 can select from different passenger categories, such as Full Fare, Concession, Free and several other types. The user can tap a “Last Ticket Details” button to fill the create transaction form with the details entered in the last transaction. When tapping this button, the application will confirm with the user 315 via a push notification whether they would like to discard their already entered details and replace them with the details entered in the last processed transaction.

The user 315 then moves on to the Select Passenger Destination portion 630 of the screen 605. The popular stops available on a route appear as a horizontal list of buttons. The user 315 can scroll through this list of buttons by tapping and dragging the list to the left or right of the screen, which scrolls through the buttons to reveal more popular stop button options. The user can also scroll through this list by tapping left & right arrows at either side of the horizontal list, or they can select a stop from the Select Stop drop-down menu. The Select Stop drop-down menu 631 includes a list of the route stops that are arranged in alphabetical order.

The user can tap one of the stop buttons to select a stop for the entered passenger types, or the user selects a stop from the drop-down menu list 631. Once the user has selected a stop, transaction details on the lower left of the screen will be updated with the corresponding price amount for the entered passenger type and passenger destination/s. The Print Ticket/s button 640 will be tappable when both the values for Passenger Type and Passenger Destination have been filled. As has been discussed above, in the event that the passenger has already defined this information using the mobile application of the respective second mobile device, it may not be necessary for the driver to input these details but merely scan the coded data presented by the second mobile device 410 in order to populate the form fields.

The driver 315 can switch between manual and automatic stop shifting 650. In particular, the user 315 can switch between shifting to the next stop manually or automatically. If the user 315 selects the automatic option, the application 320 will use the GPS unit 312 of the mobile device 310 to determine if the user has arrived at the next stop, and then switch to the transaction screen for the corresponding stop automatically. If the user selects the manual option, the driver 315 must tap the Next Stop button 660 from the Create Transaction screen 605 to go to the next stop's Create Transaction screen 605.

The driver 315 can set a transaction as a Multi-Destination transaction 670. The user confirms the action to set the transaction as Multi-Destination by a push notification to the server application 430. Once the passenger 415 has converted a transaction to “Multi-Destination,” they can revert back to a Single-Destination transaction by tapping a Revert to Single Destination button, which has replaced the Set as Multi-Destination button 670. Setting a transaction as Multi-Destination means that each passenger type added by the user will be provided with a passenger destination stop selection list. Each added stop selection list will be labelled with the corresponding passenger type above the list.

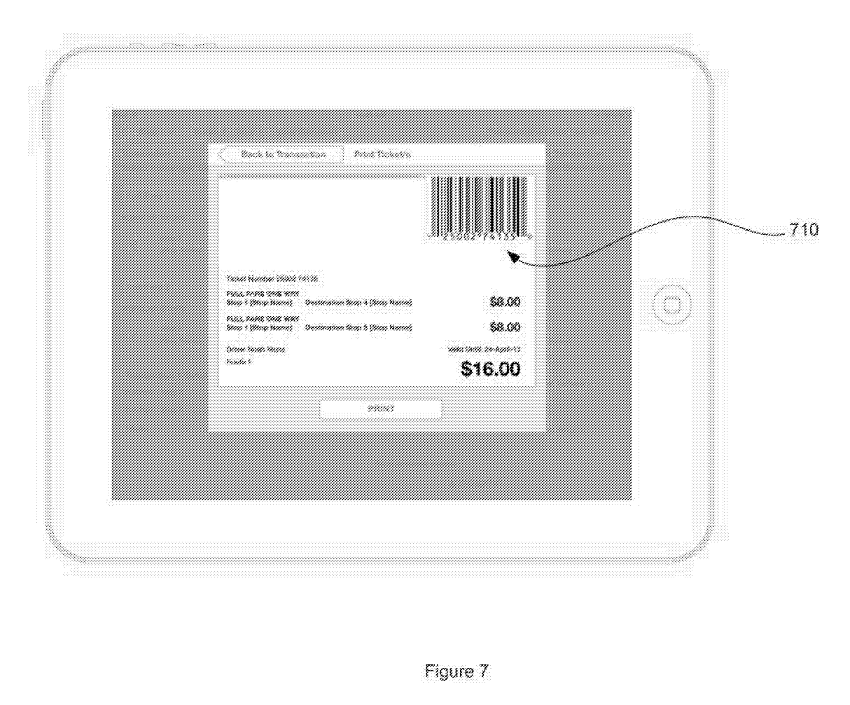

When the user 315 is satisfied with the transaction details, the user selects the “Print Ticket/s” button 660 to print the transaction ticket(s). The printer 330 prints the generated ticket(s). All tickets listed under the same transaction are printed in one ticket unless the transaction includes a special circumstance ticket. Special Circumstance tickets are printed on separate sheets. An example print preview of the ticket 710 printed is shown in FIG. 7.

When the user 315 has moved to the next stop on the route stop list either by tapping the Next Stop button or being transferred by the application automatically via the GPS unit 312, a notification appears informing the user of how many passengers will be exiting the vehicle at the current stop, according to the information gathered from the previous transaction details.

Each stop has its own transaction list which includes information about every transaction created while on the corresponding stop's Create Transaction screen 605. The user 315 is able to void ticket/s that were created from the Create Transaction screen 605 by tapping a Void Printed Ticket/s button on the relevant transaction of the Transaction List. Tickets that have been voided will still be listed on the Transaction List screen and will be included in any exported Route report for accounting purposes. The user 315 can return to the stop's Create Transaction screen by tapping the New Transaction Screen button.

The user 315 can view a list of stops that are included on their route by tapping the Stop List button from the Create Transaction screen. Here the user 315 can view the stops that are included on the route. The user can scroll up or down this list. The stop that the user 315 is currently handling appears highlighted. The user 315 can return to their current stop transaction screen by tapping the New Transaction Screen button on the highlighted stop on the list of Route Stops. Should the user 315 wish to prematurely end the route, they can tap the End Route button on the upper right hand corner of the screen.

When the user 315 arrives at the last stop on a route, the user 315 is then prompted to end the route by tapping an end route button. The user 315 is also able to go back to the previous stop's corresponding transaction list by tapping a previous stop button, the user 315 is asked to confirm their option to end the route. If the user 315 taps the end route button, they will be required to enter in their vehicle's new odometer number. When the user 315 has finished entering the new odometer number, they tap an OK button. If the user 315 chooses to end the route and export the recorded data, the user 315 will be greeted with a confirmation push notification once the data has been exported to the server processing system 430.

If the application 320 is unable to connect to the server application 440 of the server processing system 430, the application 320 will notify the user 315. The application 320 will then save the data to the unexported routes section of the application 320 in memory of the mobile device 310. The user can view the unexported data. In particular, the user 315 taps a View Unexported Routes button from an Unexported Route Push Notification screen to bring them to the Unexported Routes screen 530, which can also be accessed from the main screen of the application 320. The Unexported Routes screen 530 contains a list of routes that have been driven by the driver but that have not yet been exported to the server processing system 430. The user 315 can select a route from a list of routes from this screen 510 to view the route contents, or they can tap an EXPORT ROUTES button to export the routes on this screen 530 to the server processing system 430. The user 315 is also able to print the routes from this screen 530 by tapping a PRINT ROUTES button. The user 315 can choose to print and export individual routes from this screen 530 by tapping a Print Route button or an Export Route button for each individual Route Stop list.

The user 315 can view one or more previously exported routes. In particular, a Last Exported Routes screen 540 is provided in the same way as the Unexported Routes screen. The Last Exported Routes screen 540 includes a list of the last three routes that were exported to the server processing system 430 by the user. The user 315 is able to print the routes from this list via a print routes button available on this screen 540, or via a Print Route button available on each Exported Route Stop List screen. By selecting the Print Route button on a route from either the Unexported Routes tab 530 or the Last Exported Routes tab 540, the user 315 can view a print preview of the route document generated by the application. The user 315 can then print the route document via the printer, or the user can export the document as a PDF file by tapping an Export as PDF button. The document includes details such as the number of tickets and types sold, the net cash, tickets voided, the route number, the driver Name, the bus number/registration, and the start and finishing odometer readings for that route session. The document would also show a list of the stops on the route, and below each stop, the tickets that were issued or sold at that stop. Each route session would be generated on a separate document.

The application 310 also provides a screen including driver information 550. Tapping on the Driver Information tab from the main screen of the application 320 takes the user to the Driver Information screen 550, where the user 315 can view the information that has been entered upon login to the application 320. The user 315 can choose to edit this information by tapping the Edit Information button, which brings up an Edit Information form that the user 315 can use to edit their current Driver Information.

The user 315 can also select an Inbox tab 560 on the main screen to view a list of headers representing messages that have been delivered to the user from the server application. The user 315 can select a message to view from this screen by selecting a message header, or the user 315 can delete a message by marking the check box next to a message header and then selecting the Delete button.

If the user 315 receives a new message from the server application 440, a badge notification will appear on the Inbox tab 550 on the main screen. When the user 315 visits the Inbox, the new message header will be highlighted as long as it remains unread. The user 315 taps on one of the message headers from the inbox to display the corresponding message content.

An example user interface of a server application 440 of the server processing system 430 will now be discussed. Again, this example will be described with reference to the conveyance being a bus. However, it will be appreciated that the example is also applicable to other forms of conveyance. The server processing system 430 may be a web server which hosts the server application 440 in the form of a web application. In this configuration, an administrator 435 can interact with the server application 430 via a client processing system 436 in communication with the server processing system 430 via a web-browser application.

Initially, a login screen for the server application 440 is presented to the user. An authenticated username/email and set password will be required via the form fields and instructional/reminder text could be placed below it. When all credentials are entered correctly, the administrator 435 will be directed to a main screen.

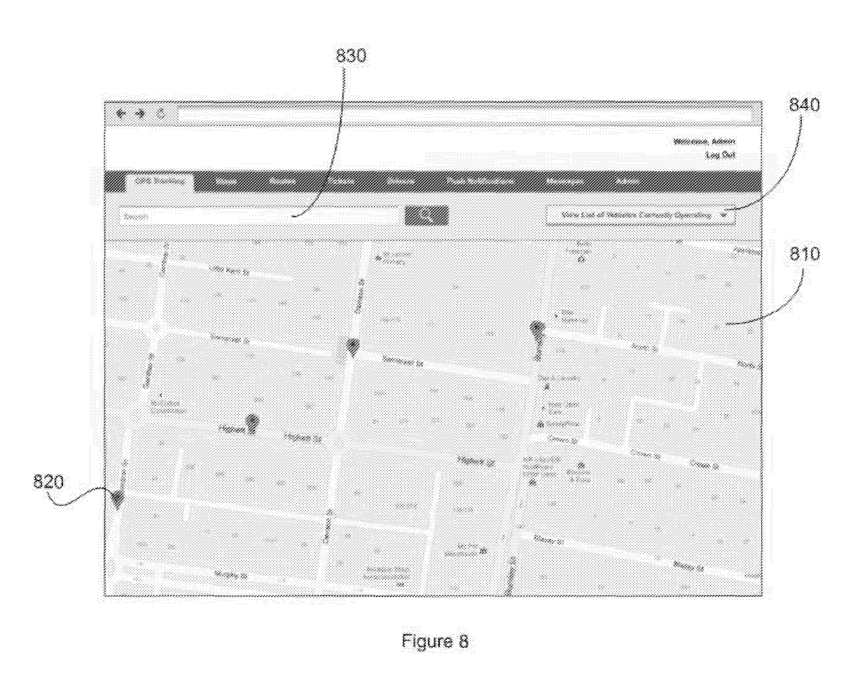

Referring to FIG. 8, upon login the administrator 435 is brought to the GPS tracking section 810 of the server application 440. The GPS tracking section of the server application 440 is composed of a map screen. The administrator 435 can see pins 820 on the map screen 810 that represent the current locations of mobile devices 310 associated with the fleet of buses. The administrator 435 can search for a specific vehicle or driver by entering key words into a search text box 830 near the top of the screen 810. The administrator 435 can click on one of the pins 820 on the GPS tracking map screen 810 to view information on the bus that the pin 820 represents via a small window. The administrator 435 can view a list of vehicles that are currently in transit by clicking a View List of Vehicles Currently Operating button 840 on the upper right corner of the screen 810. Clicking on one of the listed vehicles centres the map screen 810 on the vehicle's pin icon on the map screen and brings up the information window next to the pin 820 icon on the map. The server application 440 can use GPS data stored memory 450 and/or request GPS data from the mobile devices 310.

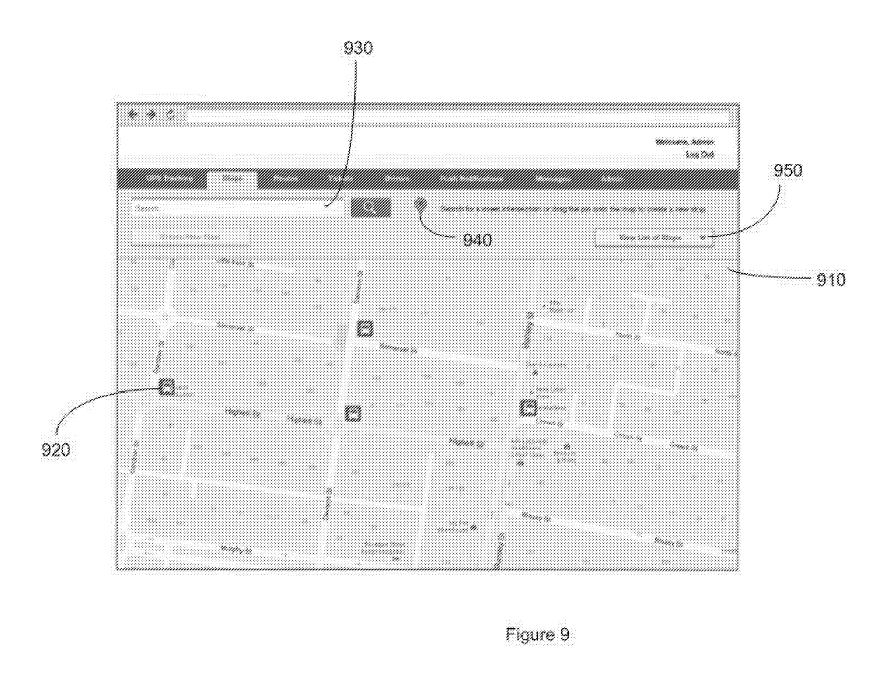

The administrator 435 can select the Stops tab on the upper navigation menu to arrive at the Stops section 910 of the server application 430 as shown in FIG. 9, which is also mainly composed of a map screen. The locations of Stops on the map screen 910 can be marked by indicia 920. The administrator can search for a specific stop by entering key words into a search text box 930 at the top of the screen 910. The administrator can click on one of the stops visible on the map screen 910 to view information about the particular stop, such as the stop name and the routes that include that stop. The steps are determined from route data stored in memory 450.

The administrator 435 can add a new stop to the stop screen map by dragging a pin icon 940 onto a spot on the map screen 910. After the administrator has dragged the pin icon 940 on to the map to create a new stop, a dialogue box appears asking the administrator to enter in a new name for the stop. The text box on the dialogue box will be automatically filled with the name of the street or the names of the cross streets from the spot on the map screen where the pin has been dragged which may be accessed from a remote server processing system.

The administrator 435 can view a list of all the stops by clicking on a View List of Stops button 950 on the upper right corner of the map screen. Clicking on one of the listed Stops centres the map screen on the stop's icon 920 on the map screen 910 and brings up the information window next to the icon on the map 910.

The administrator 435 can select a Routes tab 1010 of the server application 430 to visit the Routes section of the server application 430. At the Routes 1010 section of the server application 430, the administrator can create a new route from the New Route section 1020. In particular, the administrator 435 selects a Route category from a drop-down menu of possible route category types, and then enters in a new route name into the route Name text box. The administrator 435 clicks an Add New Route button to create the new Route. The new route data is stored in memory 450.

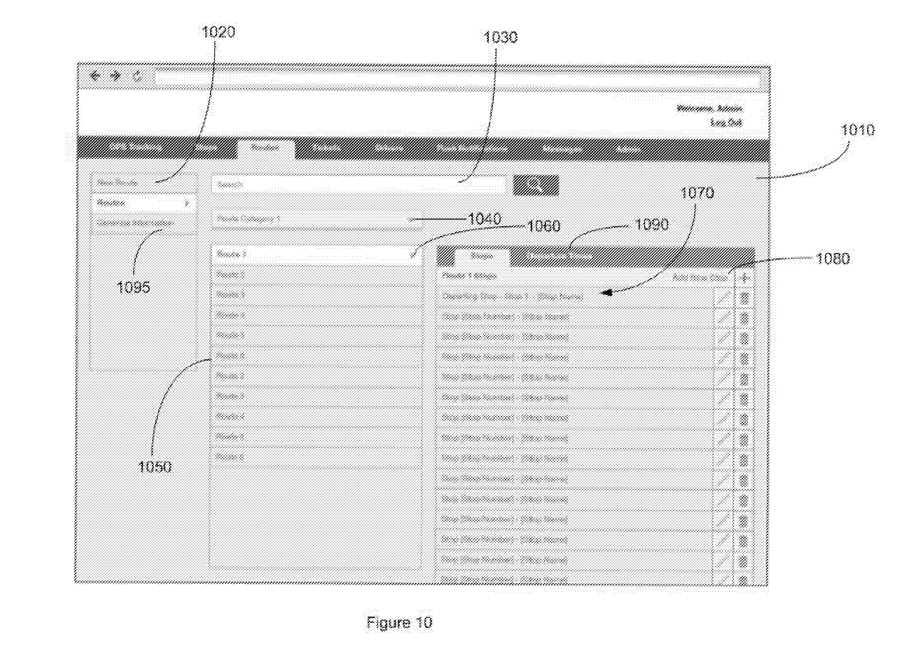

The administrator 435 can view the available routes by clicking the Routes tab within the Routes section of the server application 435 as shown inn FIG. 10. The administrator 435 can search the list of routes from memory 450 by entering key words into the search text box 4030 at the top of the screen, or they can view a list of available routes sorted by route categories by selecting a route category from the route category drop down menu 1040. Selecting a route category from the drop down menu updates the list 1050 beneath the drop down menu to display the Routes filed under that route category. The administrator 435 can select one of the routes 1060 on this list to display the list of stops included in this route to the left of the list of routes. The list of stops 1070 are arranged in the order that they are traveled, starting with the stop from which the bus departs.

The administrator 435 can add a new stop by clicking an Add New Stop button 1080 from the stops section of one of the routes 1060. A dialogue box will appear that will ask the administrator 435 to select a stop from a drop down menu. The list of stops on the drop down menu includes the stops that were added to the stops section of the server application. Once the administrator 435 has selected a stop, they select the stop's order within the route's list of stops from a drop down menu. Inserting a stop somewhere in the middle of a list of stops updates the order of the succeeding stops on the list.

The administrator 435 can select a Departure Times tab 1090 from the route window to view the route's list of departure times stored in memory 450. The departure times are the times by which vehicles start a route at the route's departing stop. The departure times are arranged in the order of earliest to latest. The administrator 435 can add a new departure time by clicking on an Add New Departure Time button from the departure times section of the screen. This action brings up a dialogue box where the user can add a new departure time by selecting the hour and minutes from drop down menus. The administrator 435 can then click the Add New Departure Time button to add the new departure time to the list of departure times.

The administrator 435 can select the Generate Information tab 1095 on the routes section of the server application 430 to visit the Generate Information section. Here the administrator 435 can select fields from the drop down menus including the type of information they would like to gather, and select dates marking time periods from which they would like to gather information. The administrator 435 can generate data regarding routes from this section of the server application 430. When the administrator 435 is satisfied with the information that they entered in the select dates text boxes and in the drop down menus, they click a Generate Information button to generate a table of data that was gathered according to the parameters set by the administrator. The administrator 435 can then export this generated data into an XLS document by clicking the Export to XLS button. The report is generated based on data stored in memory 450.

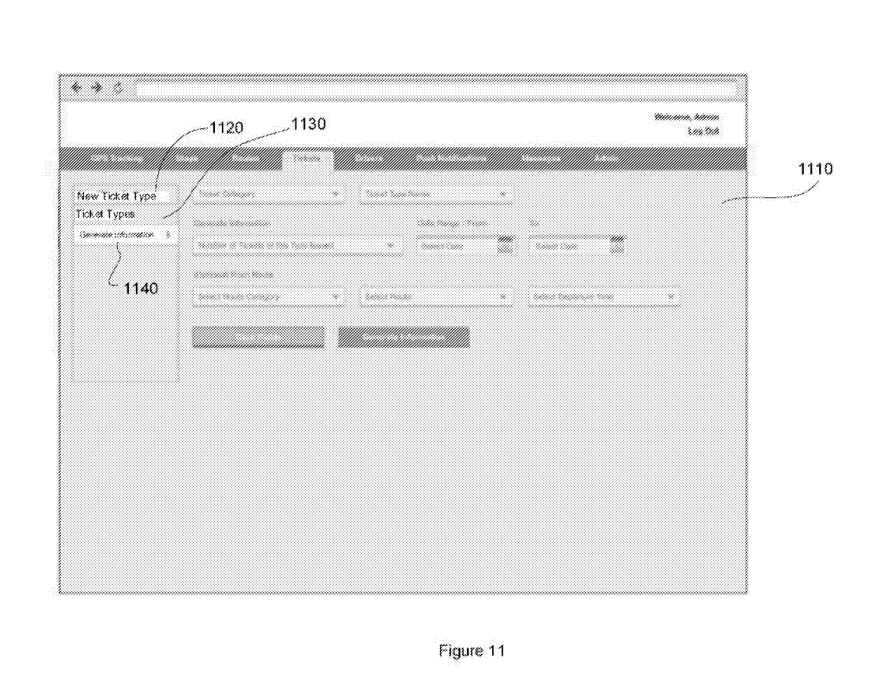

The administrator 435 can select the Tickets tab on the navigation menu to visit the Tickets section 1110 of the server application 430 as shown in FIG. 11. The administrator 435 can select the New Ticket Type tab 1120 to view a form where they can enter in information on a new ticket type. The administrator 435 preferably adds a name for the new ticket type, as well as select whether the ticket will be priced with a flat rate or a per-zone price. When the administrator 435 is satisfied with the ticket details they click a Add New Ticket Type button to add the new ticket. The ticket data is then stored in memory 450.

The administrator 435 clicks on the ticket types tab 1130 on the tickets section 1110 of the server application 430 to view a screen that lists all the available types of tickets. The tickets are listed in two tables, one table including the flat rate ticket types and another containing the tickets that are priced per zone. The administrator can edit or delete any of the items on these tables by clicking an Edit or Delete button next to each entry.

The administrator 435 can click on the Generate Information tab 1140 on the tickets section 1110 of the server application 430 to visit the Generate Information section. Here the administrator can select fields from drop down menus including the type of information they would like to gather, and select dates marking time periods from which they would like to gather information. The administrator can generate data regarding tickets from this section of the server application 430. The generated report is based on data stored in memory 450.

When the administrator 435 is satisfied with the information that they entered in Select Dates text boxes and in the drop down menus, they click a Generate Information button to generate a table of data that was gathered according to the parameters set by the administrator. The administrator can then export this generated data into a spreadsheet document by clicking the Export button.

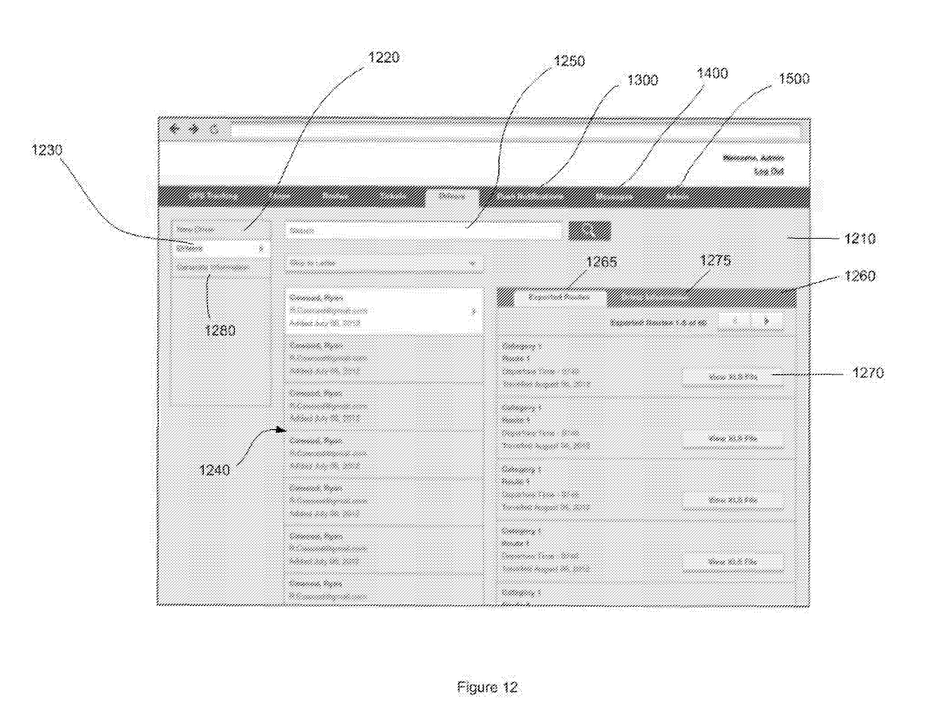

The administrator 435 can select a Drivers tab 1210 on the navigation menu to visit the drivers section of the server application 430 as shown in FIG. 12. The administrator 435 clicks on the New Driver tab 1220 to view a form where they can enter in information on a new Driver. The administrator 435 preferably adds a valid email address for the New Driver, as well as enter in the driver's first name and last name. When the administrator 435 is satisfied with the new driver details they click an Add New Driver button to add the new driver. The driver data is stored in memory 450.

The administrator 435 clicks on the drivers tab 1230 of the drivers section 1210 of the server application 430 to view a list of the drivers 1240 that have currently been added to the data store of the server application 430. The list of drivers 1240 that have been added to memory 450 of the server application 430 are arranged by the driver's surnames in alphabetical order. The administrator 435 can search this database of drivers by entering keywords into a search text box 1250 at the top of the screen 1210, or they can skip to a letter by selecting a letter from the Skip to Letter drop down menu. Clicking on one of the driver's names brings up a window 1260 to the right of the list of drivers that displays a list of routes 1265 that the driver has exported from the application of the mobile device. The administrator 435 clicks on a View XLS File button 1270 to generate the XLS file that the driver exported to the server application 430.

The administrator 435 is able to select the driver information tab 1275 to view information about the driver, including their registered email address, the date that they were added to the server application 430, the number of routes that they have currently exported, etc. On this window will also exist a button to reset the driver's current password which is used for logging in.

The administrator 435 is able to select the Generate Information tab 1280 on the drivers section 1210 of the server application 430 to visit the Generate Information section. Here the administrator 435 can select fields from drop down menus including the type of information they would like to gather, and select dates marking time periods from which they would like to gather information. The administrator can generate data regarding routes from this section of the server application 430. When the administrator 435 is satisfied with the information that they entered in the select dates text boxes and in the drop down menus, they click a Generate Information button to generate a table of data that was gathered according to the parameters set by the administrator 435. The administrator 435 can then export this generated data into a spreadsheet by clicking an Export to XLS button. The report is generated based on the data stored in memory 450.

The administrator 435 is able to select the Push Notifications tab 1300 from the navigation menu which brings the administrator 435 to the Push Notifications section of the server application 430. From the new notification section, the administrator 435 can compose push notifications that will be delivered to all users 315 of the plurality of mobile devices 310. The administrator 435 adds text to a new notification text box, and then clicks the send notification button to send the new notification to all users 315 of the system.

The administrator 435 can view past notifications that have been sent from the server application 430 by clicking on a sent notifications tab. The administrator 435 can delete items from a list by marking a check box next to an item on this list and then clicking a Delete button.

The administrator 435 can select a New Message Push Notification tab to view the current push notification that has been delivered to all users of the system automatically when an administrator sends a message from the messages section of the server application 430.

The administrator 435 is able to select the Messages tab 1400 to visit the Messages section of the server application 430. The administrator 435 selects a New Message tab to view a New Message form, which is composed of a text box where the administrator 435 can add text for a new Message. When the administrator 435 is satisfied with the message text, they click a Send Message button to send the message to all users 315 of the system.

The administrator 435 is able to select a Sent Messages tab on the messages section of the server application 430 to view the messages that have been sent to all users 315 of the system. The message content text on this list appears shortened to fit within a header on the sent messages list. The administrator 435 can delete a message from this list by marking a check box next to a message item and then clicking the Delete button. The administrator 435 can view the entire message text by clicking on the content text from one of the message headers from the sent messages section of the server application.

The administrator 435 is able to create a new administrator by filling in a form at the New Admin section 1500 of the server application 430. The administrator 435 fills in relevant details into a New Admin form and then clicks an Add New Admin Member button to create the new administrator account which is stored in memory 450.

By clicking on a My Admin Profile tab from the Admin section 1500 of the server application 430 takes the administrator 235 to a My Admin Profile section of the server application 430, where they can view their administrator email account, when their profile was created and by which admin member, and other relevant details. Also present on this screen is a button the administrator 435 can click to reset their administrator password.

The administrator 435 clicks on a Current Admin tab on the Administration section 1500 of the server application 430 to view the list of current administrator accounts. An administrator account can be removed by clicking the Delete Profile button at the top right of each administrator account.

Throughout this specification and the claims which follow, unless the context requires otherwise, the word “comprise”, and variations such as “comprises” or “comprising”, will be understood to imply the inclusion of a stated integer or step or group of integers or steps but not the exclusion of any other integer or step or group of integers or steps.

Many modifications will be apparent to those skilled in the art without departing from the scope of the present invention.

1. A processing system for ticket management of a conveyance, wherein the processing system is a mobile device including a processor, a memory and a location unit, wherein the processing system is configured to:
determine, using the location unit, a current location of the conveyance;
receive a request to issue a ticket to a passenger, wherein the request is indicative of the destination for the passenger;
generate a ticket based on the current location and the destination; and
store a ticket record in a ticket data store of the memory.

2. The processing system according to claim 1, wherein the processing system is configured to instruct a printer to print a physical version of the ticket.

3. The processing system according to claim 1, wherein the processing system determines, using the current location, one or more ticket records in the memory, and route data stored in the memory, if the conveyance is to stop at an upcoming location, wherein in response to a positive determination the processing system indicates a stop reminder.

4. The processing system according to claim 1, wherein the processing system includes or is in communication with a coded data capturing device, wherein the processing system is configured to:
receive captured data from the coded data capturing device operated to capture pre-purchased ticket data presented by a passenger processing system associated with the passenger, wherein the pre-purchased ticket data is indicative of a pre-purchased ticket by the passenger;
determine based on at least one of ticket data stored in memory and a remote ticket data store, whether the pre-purchased ticket is valid; and
present, based on the determination, the validity of the pre-purchased ticket.

5. The processing system according to claim 1, wherein the processing system includes or is in communication with a coded data capturing device, wherein the processing system is configured to:
receive captured data from the coded data capturing device operated to capture coded data presented by a passenger processing system associated with the passenger, wherein the captured data is indicative of a ticket details for a requested ticket for the passenger; and
generate the ticket based on the current location and the ticket details indicated by the captured data.

6. The processing system according to claim 1, wherein the processing system is configured to:
determine an identity for a passenger processing system associated with the passenger for purchasing a ticket; and
presenting an alert in the event that a signal indicative of the identity of the passenger processing system is received after the conveyance has proceeded past the passenger's destination.

7. The processing system according to claim 1, wherein the processing system is configured to:
determine, using the location unit, location data indicative of a plurality of time-stamped locations whilst the conveyance is travelling; and
transfer, to a server processing system, at least some of the location data in order to provide a current location of conveyance to one or more querying devices.

8. A non-transitory computer readable medium including executable instructions for configuring a processing system for ticket management of a conveyance, wherein the processing system is a mobile device including a processor, a memory and a location unit, wherein the executable instructions configure the processing system to:
determine, using the location unit, a current location of the conveyance;
receive a request to issue a ticket to a passenger, wherein the request is indicative of the destination for the passenger;
generate a ticket based on the current location and the destination; and
store a ticket record in a ticket data store of the memory.

9. The non-transitory computer readable medium according to claim 8, wherein the processing system is configured to instruct a printer to print a physical version of the ticket.

10. The non-transitory computer readable medium according to claim 8, wherein the processing system determines, using the current location, one or more ticket records in the memory, and route data stored in the memory, if the conveyance is to stop at an upcoming location, wherein in response to a positive determination the processing system indicates a stop reminder.

11. The non-transitory computer readable medium according to claim 8, wherein the processing system includes or is in communication with a coded data capturing device, wherein the processing system is configured to:
receive captured data from the coded data capturing device operated to capture pre-purchased ticket data presented by a passenger processing system associated with the passenger, wherein the pre-purchased ticket data is indicative of a pre-purchased ticket by the passenger;
determine based on at least one of ticket data stored in memory and a remote ticket data store, whether the pre-purchased ticket is valid; and
present, based on the determination, the validity of the pre-purchased ticket.

12. The non-transitory computer readable medium according to claim 8, wherein the processing system includes or is in communication with a coded data capturing device, wherein the processing system is configured to:
receive captured data from the coded data capturing device operated to capture coded data presented by a passenger processing system associated with the passenger, wherein the captured data is indicative of a ticket details for a requested ticket for the passenger; and
generate the ticket based on the current location and the ticket details indicated by the captured data.

13. The non-transitory computer readable medium according to claim 8, wherein the processing system is configured to:
determine an identity for a passenger processing system associated with the passenger for purchasing a ticket; and
presenting an alert in the event that a signal indicative of the identity of the passenger processing system is received after the conveyance has proceeded past the passenger's destination.

14. The non-transitory computer readable medium according to claim 8, wherein the processing system is configured to:
determine, using the location unit, location data indicative of a plurality of time-stamped locations whilst the conveyance is travelling; and
transfer, to a server processing system, at least some of the location data in order to provide a current location of conveyance to one or more querying devices.

15. A system for management of a conveyance fleet, wherein the system includes:
a plurality of processing systems, each processing system being configured according to claim 7; and
a server processing system in communication with the plurality of processing systems.

16. The system according to claim 15, wherein the system includes a computer readable medium for configuring a passenger processing system, wherein the passenger processing system is configured to issue to a server processing system a request for estimated time of arrival at a departure point for a conveyance of the conveyance fleet, wherein the server processing system is configured to determine, based on the at least some of the location for the conveyance the estimated time of arrival and transfer a response indicative of the estimated time of arrival to the passenger processing system.

17. The system according to claim 16, wherein the passenger processing system includes a GPS unit, wherein the departure point of the request is generated using a current location indicated by the GPS unit of the passenger processing system.

18. The system according to claim 16, wherein the server processing system determines the estimated time of arrival further based on historical data.

19-20. (canceled)

21. The processing system according to claim 6, wherein one or more repeaters are mounted within the conveyance, wherein the processing system is configured to receive, from at least one of the one or more repeaters, the signal indicative of the identity of the passenger processing system.

22. The processing system according to claim 5, wherein the processing system includes or is in communication with a coded data capturing device, wherein the processing system is configured to:
determine an identity of the passenger processing system based on the captured data received from the coded data capturing device, wherein the captured data is indicative of the device identity of the passenger processing system;
receive, via one or more repeaters mounted within the conveyance and after the conveyance has proceeded past the passenger's destination, a signal indicative of the identity of the passenger processing system; and
present an alert indicative of the passenger being located on the conveyance after the conveyance has proceeded past the passenger's destination.
